(19) United States
(12) Patent Application Publication
(10) Pub. No.: US 2026/0217555 A1
(43) Pub. Date: Jul. 30, 2026

(54) METHODS OF MAKING SACRIFICIAL CATHODE ADDITIVES FOR LITHIUM-ION BATTERIES AND A HIGH FLUORINE DISORDERED ROCK-SALT CATHODE MATERIAL

(71) Applicant: THE REGENTS OF THE UNIVERSITY OF CALIFORNIA, Oakland, CA (US)

(72) Inventors: Haegyum KIM, Emeryville, CA (US); Venkata Sai AVVARU, Berkeley, CA (US); KyuJung JUN, Berkeley, CA (US)

(21) Appl. No.: 19/457,356

(22) Filed: Jan. 23, 2026

Related U.S. Application Data
(60) Provisional application No. 63/749,211, filed on Jan. 24, 2025.

(51) Int. Cl. C01G 45/1228

(52) U.S. Cl. CPC C01G 45/1228; C01P 2002/72; C01P 2004/04; C01P 2006/40

(57) ABSTRACT

This disclosure provides systems, methods, and apparatus related to high fluorine disordered rock-salt materials. In one aspect Li₆MnO₄, MnF₂, and TiO₂ are mixed to form a mixture. The mixture is ball milled. After the ball milling, the mixture is annealed at about 800° C. to 850° C. for about 2 hours to 10 hours, to form a compound. The compound is Li₁₊ₓMn_{y}Ti_{1-x-y}O_{2-z}F_{z}, with x about 0.1 to 0.4, with y about 0.3 to 0.7, and with z>0.2.

### RELATED APPLICATIONS

This application claims priority to U.S. Provisional Patent Application No. 63/749,211, filed 24 Jan. 2025, which is hereby incorporated by reference.

### STATEMENT OF GOVERNMENT SUPPORT

This invention was made with government support under Contract No. DE-AC02-05CH11231 awarded by the U.S. Department of Energy. The government has certain rights in this invention.

### BACKGROUND

The development of next-generation Li-ion batteries with improved energy density is important in addressing the ever-increasing demand for electrochemical energy storage devices in various sectors, including electric transportation, portable devices, and grid-scale energy storage systems. A key remaining challenge is the low coulombic efficiency in the first few cycles, which largely stems from the formation of a solid electrolyte interphase (SEI). This issue becomes especially problematic when high-capacity alloying anode materials, such as Si or Sn, are added to the anode composite to increase the cell energy density. In this case, loss of accessible lithium in the cell is triggered, eventually reducing the total energy that the system can store during its operation.

The development of next-generation Li-ion batteries with improved energy density is needed to meet the ever-increasing demand for electrochemical energy storage devices. Disordered rocksalt cathode materials are considered promising candidates for high energy density. However, their rapid capacity degradation remains a challenge.

### SUMMARY

One innovative aspect of the subject matter described in this disclosure can be implemented in a method including mixing Li₂O and MnO to form a mixture. The mixture is annealed at about 900° C. to 1100° C. for about 2 hours to 24 hours. The mixture is cooled at a rate of about 30° C./min to 7000° C./min to form Li₆MnO₄.

Another innovative aspect of the subject matter described in this disclosure can be implemented in a method including mixing Li₆MnO₄, MnF₂, and TiO₂ to form a mixture. The mixture is ball milled. After the ball milling, the mixture is annealed at about 800° C. to 850° C. for about 2 hours to 10 hours to form a compound. The compound is Li₁₊ₓMn_{y}Ti_{1-x-y}O_{2-z}F_{z}, with x about 0.1 to 0.4, with y about 0.3 to 0.7, and with z>0.2.

Another innovative aspect of the subject matter described in this disclosure can be implemented in a method including mixing Li₂O and MnO to form a mixture. The mixture is annealed at about 900° C. to 1100° C. for about 2 hours to 24 hours. The mixture is cooled at a rate of about 30° C./min to 7000° C./min, forming Li₆MnO₄. MnF₂, TiO₂, and the Li₆MnO₄ are mixed to form a second mixture. The second mixture is ball milled. After the ball milling, the second mixture is annealed at about 800° C. to 850° C. for about 2 hours to 10 hours to form a compound. The compound is Li₁₊ₓMn_{y}Ti_{1-x-y}O_{2-z}F_{z}, with x about 0.1 to 0.4, with y about 0.3 to 0.7, and with z>0.2.

Details of one or more embodiments of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A shows an example of a flow diagram illustrating a manufacturing process for a high fluorine disorder rock-salt material. FIG. 1B shows an example of a flow diagram illustrating a manufacturing process for lithium manganese oxide (Li₆MnO₄).

FIGS. 2A-2F show the results of in situ characterization of Li₆MnO₄ synthesis. FIG. 2A shows a heatmap showing XRD intensities collected from a sample of Li₂O and MnO that was heated to 950° C. and slowly cooled to synthesize Li₆MnO₄. FIG. 2B shows a heating profile associated with the experiment shown in FIG. 2A. FIG. 2C shows weight fractions obtained from the XRD measurements shown in panel FIG. 2A. FIG. 2 D shows a heatmap showing the XRD intensities collected from a sample of Li₂O and MnO, which was heated to 950° C., rapidly cooled to 600° C., and held for 20 h before letting the sample slowly cool to room temperature. FIG. 2E shows a heating profile associated with the experiment shown in FIG. 2D. FIG. 2F shows weight fractions obtained from the XRD measurements shown in FIG. 2D

FIGS. 3A-3D show structure characterization of synthesized Li₆MnO₄ under varied conditions. FIG. 3A shows XRD patterns of the synthesized Li₆MnO₄ with varied cooling rates and FIG. 3B shows a corresponding weight fraction analysis of Li₆MnO₄, Li₂O, and MnO. FIG. 3C shows XRD patterns of the synthesized Li₆MnO₄ at varied Li₂O:MnO ratios (varied Li excess level). FIG. 3D shows Rietveld refinement result of Li₆MnO₄ synthesized with 40% Li excess.

FIGS. 4A-4C show in situ electrochemistry-XRD characterization. FIG. 4A shows XRD heat maps of Li₆MnO₄ during charging and FIG. 4B shows associated charge-discharge profiles at 5 mA g⁻¹. FIG. 4C shows XRD patterns of Li₆MnO₄ during charging. Scan from every 16 h (80 mAh g⁻¹).

FIGS. 5A-5D show the characterization of Li₆MnO₄ during the charging process. FIG. 5A shows a first charge profile of Li₆MnO₄ at 10 mA g⁻¹. FIG. 5B shows ex situ XANES analysis (Mn K-edge) of Li₆MnO₄ electrodes at varied charged states. FIG. 5C shows O-K mapping of mRIXS of Li₆MnO₄ electrodes at varied charged states. FIG. 5D shows the DEMS analysis results of Li₆MnO₄ electrode at 10 mA g⁻¹.

FIGS. 6A-6F show electrochemical properties of cells with and without Li₆MnO₄ additive. Charge-discharge profiles of (FIG. 6A) NMC811 cathode and (FIG. 6B) NMC811 with Li₆MnO₄ additive in a Li metal half-cell. FIG. 6C shows charge-discharge profiles of the SiOₓ-graphite composite anode in a Li metal half-cell. Charge discharge profiles of (FIG. 6D) NMC811 cathode and (FIG. 6E) NMC811 with Li₆MnO₄ additive in a full-cell with the SiOₓ-graphite composite anode. FIG. 6F shows the cycling performance of the full cells with and without Li₆MnO₄ additive.

FIGS. 7A-7D show the results of characterization of the synthesized LMTOF1244. FIG. 7A shows XRD pattern of LMTOF1244-800, refined based on the rock-salt structure (space group: Fm-3 m). FIG. 7B shows ¹⁹F ssNMR spectra collected on as-synthesized LMTOF1244-800, -900, -1000 (using Li₆MnO₄, MnF₂, and TiO₂ precursors) and the reference sample synthesized using conventional precursors of LiF, Li₂O, MnO, and TiO₂ at 1000° C. A long recycle delay of 20 s was used to ensure full relaxation of all the ¹⁹F ssNMR signals between scans for quantification. The spectra were scaled according to the sample mass in the rotor and the number of scans used during the data acquisition. FIG. 7C shows Mn-L₃ edge mRIXS-iPFY spectra of LMTOF1244-800 and fluorine-free LMTO1240, which was synthesized with Li₂O, Mn₂O₃, and TiO₂ at 1000° C. References of Mn^{2+/3+/4+}, including MnO (Mn²⁺), Mn₂O₃ (Mn³⁺), and Li₂MnO₃ (Mn⁴⁺), are plotted at the bottom for direct comparison. The solid lines correspond to semi-quantitative fitting results of spectra by the linear combination of reference spectra. FIG. 7D shows Ti-L₃ edge RIXS spectra of LMTOF1244-800 and fluorine-free LMTO1240 at 457.6 eV of excitation energy. The highlighted region corresponds to the dd-excitation energy range. The absence of peaks in this region indicates that there is no d-electron to be excited; therefore, Ti only has the d° component, which is Ti⁴⁺.

FIG. 8A shows an HAADF STEM image of LMTOF1244-800 and the fast Fourier transform (FFT) pattern of the image. FIG. 8B shows an electron diffraction pattern of LMTOF1244-800 acquired along the [001] zone axis. FIG. 8C shows an STEM image and EDS mapping results of the elements (FIG. 8D) Mn, (FIG. 8E) Ti, (FIG. 8F) O, and (FIG. 8G) F in LMTOF1244-800.

### DETAILED DESCRIPTION

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise.

The terms “about” or “approximate” and the like are synonymous and are used to indicate that the value modified by the term has an understood range associated with it, where the range can be ±20%, ±15%, ±10%, ±5%, or ±1%. The terms “substantially” and the like are used to indicate that a value is close to a targeted value, where close can mean, for example, the value is within 80% of the targeted value, within 85% of the targeted value, within 90% of the targeted value, within 95% of the targeted value, or within 99% of the targeted value.

Pre-lithiation has been suggested as a strategy to compensate for the lithium loss in a cell by adding excess lithium to the anode or cathode. Typical pre-lithiation methods include electrochemical pre-lithiation, chemical pre-lithiation, and the introduction of pre-lithiation additives to either the cathode or anode. Among these methods, pre-lithiation additives used in cathode composites have drawn significant attention because they avoid the challenges of handling highly reactive anode components and require only a simple modification of the manufacturing process. A cathode pre-lithiation additive irreversibly releases lithium during the first charging process to compensate for the initial lithium loss, and the residue remains inactive in the cathode composite during the remaining life of the cell. As such, they are often referred to as sacrificial cathode additives.

An ideal sacrificial cathode additive irreversibly releases a large amount of lithium in the first charging process, and its residue remains stable during battery operation without causing any detrimental side reactions. Several high-lithium-content transition-metal oxides have been investigated as sacrificial cathode additives. For example, antifluorite Li₅FeO₆ has been proposed as a viable candidate material due to its low cost and high irreversible capacity. However, its poor stability in the air remains a problem. Another antifluorite-structured material, Li₆CoO₄, has been widely investigated; yet, the reactivity of its charging residue and the use of cobalt remain drawbacks. Other materials such as Li₂MoO₃, Li₂CuO₂, and Li₂NiO₂ have been investigated; however, they provide lower irreversible lithium release capacities than antifluorite compounds.

In embodiments described herein, high-purity Li₆MnO₄ (>about 85 wt %) is synthesized using excess Li₂O and fast cooling. Without excess Li₂O and fast cooling, about 40 wt % to 60 wt % of Li₆MnO₄ can be achieved with Li₂O and MnO impurities.

In embodiments described herein, high fluorine disordered rock salt (DRX) cathodes are synthesized at relatively low temperature (e.g., about 800° C.) using Li₆MnO₄. Typically, DRX cathodes can only form at >about 900° C., which is higher than the melting temperature of LiF, the typical fluorine source. Due to the lower synthesis temperature, high fluorine content is incorporated in the DRX structure.

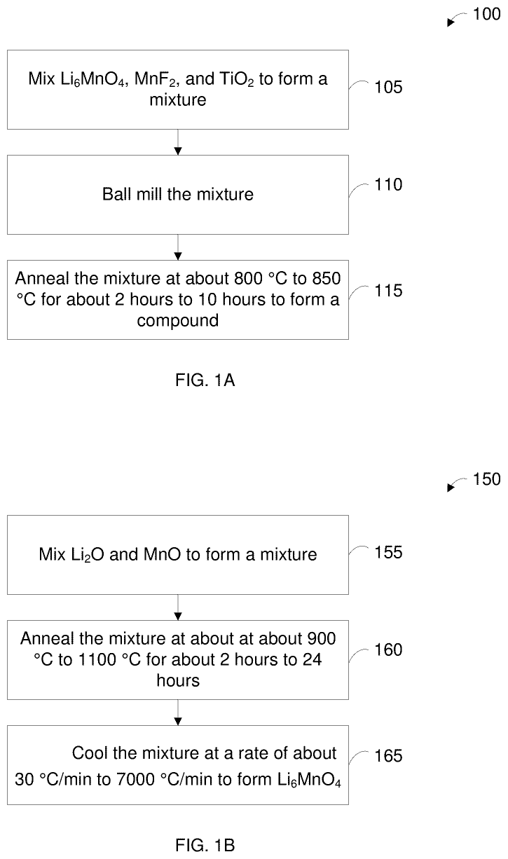

FIG. 1B shows an example of a flow diagram illustrating a manufacturing process for lithium manganese oxide (Li₆MnO₄). Starting at block 155 of the method 150 shown in FIG. 1B, Li₂O and MnO are mixed to form a mixture. In some embodiments, the mixture includes only Li₂O and MnO. In some embodiments, the ratio of Li₂O to MnO is about 3 to 1 by mole fraction. In some embodiments, the mixture includes excess Li₂O. In some embodiments, the mixture includes excess (e.g., about 20% to 50% by mole fraction, or about 40% by mole fraction) Li₂O.

In some embodiments, the mixing is performed for about 2 hours to 8 hours, about 2 hours to 4 hours, or about 3 hours. In some embodiments, the mixing is performed using a planetary mixer.

At block 160, the mixture is annealed at about 900° C. to 1100° C., or about 950° C., for about 2 hours to 24 hours, about 6 hours to 12 hours, or about 8 hours. In some embodiments, the annealing is performed under flowing hydrogen and argon or mixed hydrogen and argon. In some embodiments, the mixture is annealed in a furnace or other heating apparatus.

At block 165, the mixture is cooled at a rate of about 30° C./min to 7000° C./min, about 30° C./min to 1,000° C./min, about 30° C./min to 200° C./min, about 30° C./min to 60° C./min, about 40° C./min to 50° C./min, about 50° C./min to 200° C./min, about 75° C./min to 200° C./min, about 100° C./min to 500° C./min, about 100° C./min to 200° C./min, about 100° C./min to 300° C./min, about 150° C./min to 200° C./min, about 300° C./min to 7,000° C./min, or about 500° C./min to 1,000° C./min, to form Li₆MnO₄. Different methods to cool the mixture at these cooling rates can be used, including: cooling the mixture in a furnace (i.e., the furnace or other apparatus in which the mixture is annealed at block 160) with a fan directed at the mixture; removing the mixture from the furnace (this would cool the mixture faster as the furnace one would not need to wait for the furnace to cool; i.e., the mixture by itself has a lower thermal mass than the mixture in the furnace); removing the mixture from the furnace and cooling the mixture with a fan directed at the mixture; and removing the mixture from the furnace and cooling the mixture by immersing the mixture in liquid nitrogen, water, or other liquid. In some embodiments, a faster cooling rate yields Li₆MnO₄ with a higher purity.

In some embodiments, the method 150 further comprises forming a compact of the mixture prior to the annealing. The compact is then annealed.

In some embodiments, the Li₆MnO₄ generated with the method 150 has a purity of 85% by weight or greater.

FIG. 1A shows an example of a flow diagram illustrating a manufacturing process for a high fluorine disorder rock-salt material. Starting at block 105 of the method 100 shown in FIG. 1A, Li₆MnO₄, MnF₂, and TiO₂ are mixed to form a mixture. In some embodiments, the mixture includes only Li₆MnO₄, MnF₂, and TiO₂. In some embodiments, the mixture includes about 25 mol % Li₆MnO₄, about 25 mol % MnF₂, and about 50 mol % TiO₂.

In some embodiments, the Li₆MnO₄ has a purity of 85% by weight or greater. In some embodiments, the lithium manganese oxide used in the method 100 shown in FIG. 1A is formed by the method 150 shown in FIG. 1B.

At block 110, the mixture is ball milled. In some embodiments, ball milling the mixture is performed using a planetary ball mill. In some embodiments, the ball milling is performed for about 1 hour to 10 hours, about 1 hour to 5 hours, or about 3 hours.

At block 115, after the ball milling, the mixture is annealed at about 800° C. to 850° C. for about 2 hours to 10 hours, about 3 hours to 5 hours, or about 4 hours, to form a compound. The compound is or consists essentially of Li₁₊ₓMn_{y}Ti_{1-x-y}O_{2-z}F_{z}, with x about 0.1 to 0.4, with y about 0.3 to 0.7, and with z>0.2. In some embodiments, the mixture is annealed in a furnace or other heating apparatus.

In some embodiments, the annealing is performed under an inert atmosphere. In some embodiments, the annealing is performed under flowing argon.

In some embodiments, the compound is or consists essentially of Li_{1.23}Mn_{0.4}Ti_{0.37}O_{2-z}F_{z}, with z is about 0.29 to 0.34. In some embodiments, the compound is or consists essentially of Li_{1.2}Mn_{0.4}Ti_{0.4}O_{1.6}F_{0.4}.

In some embodiments, the method 100 further comprises forming a compact of the mixture prior to the annealing. The compact is then annealed.

Described in the EXAMPLES below is a study of the synthesis of Li₆MnO₄ (specifically antifluorite-structured Li₆MnO₄), a candidate for sacrificial cathode additives. In situ X-ray diffraction (XRD) and density functional theory (DFT) calculations of reaction energies were used in the study. Once synthesized with reasonably high purity, the Li extraction mechanism of Li₆MnO₄ was determined using X-ray absorption spectroscopy (XAS), resonant inelastic X-ray scattering (RIXS), and differential electrochemical mass spectrometry (DEMS). This work showcases the effectiveness of Li₆MnO₄ as a sacrificial cathode additive, motivating future investigation into this compound and other structurally related materials identified using computations.

Further described in the EXAMPLES below is a highly fluorinated DRX phase with the composition Li_{1.23}Mn_{0.40}Ti_{0.37}O_{2-y}F_{y} (y=0.29-0.34) that can be synthesized via a solid-state reaction using the precursors of Li₆MnO₄, MnF₂, and TiO₂. Using the precursors Li₆MnO₄, MnF₂, and TiO₂, can avoid the formation of Mn-based intermediates (such as Li₂(Mn,Ti)O₃, LiMnO₂, and Mn₃O₄), which have negligible solubility of fluorine that results in fluorine evaporation before incorporation in the disordered rock-salt phase formation. This synthesis method allows Mn and F ions to be involved in the DRX formation at a relatively low temperature without substantial fluorine evaporation. Additionally, the fluorinated DRX cathode exhibits a high specific capacity (>300 mAh g⁻¹) and high specific energy (>980 Wh kg⁻¹).

The following examples are intended to be examples of the embodiments disclosed herein, and are not intended to be limiting.

### Example—Synthesis of Li₆MnO₄

Li₂O and MnO were homogeneously mixed by using a planetary ball mill at 250 rpm for 4 hours. The ball-milling jar was sealed in an Ar-filled glovebox to avoid air exposure of the powder. The mixture was pelletized with a mold with a 12 millimeter diameter. The pelletized samples were annealed to form the target phase at 950° C. for 12 hours under a continuous flow of the mixed gas (98% Ar, 2% H₂), followed by different cooling processes.

### Example—Understanding Li₆MnO₄ Synthesis Mechanisms

The first synthesis of Li₆MnO₄ was reported by researchers who mixed Li₂O and MnO in a 3:1 ratio and heated the sample at 950° C. for 12 h under a reducing atmosphere (99% N₂, 1% H₂) before letting it cool naturally to room temperature. Despite the reported success of this synthesis procedure, the XRD pattern acquired from its product deviates from that anticipated for Li₆MnO₄, suggesting that prominent impurities may be present. Later work by a different research group reaffirmed the presence of substantial impurity peaks that arise from an attempted synthesis of Li₆MnO₄.

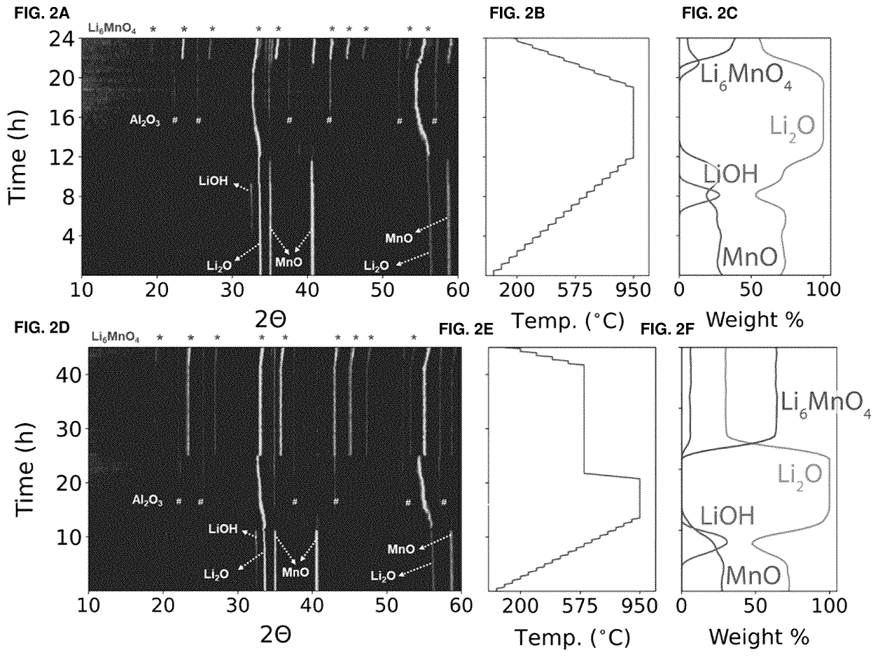

To better understand how Li₆MnO₄ forms during solid-state synthesis and to identify the secondary phases that limit its purity, in situ XRD measurements were performed on a precursor mixture of Li₂O and MnO that was heated to 950° C., held for 8 hours, and cooled to room temperature under a reducing atmosphere (98% Ar, 2% H₂). FIGS. 2A-2C show the phase transformation observed during this synthesis process. Li₂O does not react with MnO at temperatures below 900° C., although a small amount of LiOH temporarily forms due to the presence of H₂ in the reducing atmosphere. Above 900° C., two noticeable changes in the XRD patterns were seen: i) the diffraction peaks associated with MnO disappear and ii) the peaks associated with Li₂O undergo a prominent shift toward lower 2θ, consistent with lattice expansion. The simultaneous occurrence of these two changes suggests the incorporation of the larger Mn²⁺ ions (66 pm) into the antifluorite structure of Li₂O (where Li⁺ has a smaller ionic radius of 59 pm).

DFT calculations and Monte Carlo simulations indicated that it is thermodynamically favorable for tetrahedral cations in Li₆MnO₄ to disorder above ≈700° C. The presence of a disordered Li₆MnO₄ phase at high temperatures is further evidenced by the fact that the ordered version of this phase appears during cooling (≤600° C.). However, the formation of ordered Li₆MnO₄ is accompanied by its partial decomposition into MnO and Li₂O. As a result, the final product contained only ≈40% Li₆MnO₄ by weight.

To improve the purity of Li₆MnO₄ in its ordered configuration, a second experiment was performed where the sample was rapidly cooled from 950 to 600° C. and held for 20 h before being slowly cooled to room temperature. The XRD patterns collected during this synthesis experiment are shown in FIGS. 2D-2F, revealing an increased yield of ordered Li₆MnO₄ that reaches 65 wt. % by the end of cooling. These results suggest that Li₆MnO₄ is only stable at high temperature, and therefore, rapid cooling is needed to avoid (or at least minimize) its decomposition into Li₂O and MnO. From DFT calculations, Li₆MnO₄ is indeed metastable at 0 K, with an energy of 6 meV atom⁻¹ above the convex hull. However, configurational disorder on cation sites in Li₆MnO₄ can significantly lower its free energy at high temperature—on the order of 100 meV atom⁻¹—thereby stabilizing this phase relative to Li₂O and MnO. To capitalize on the stability of Li₆MnO₄ that occurs at high temperature while retaining it at low temperature, the effectiveness of fast cooling was further investigated.

### Example—Synthesis Optimization of Li₆MnO₄

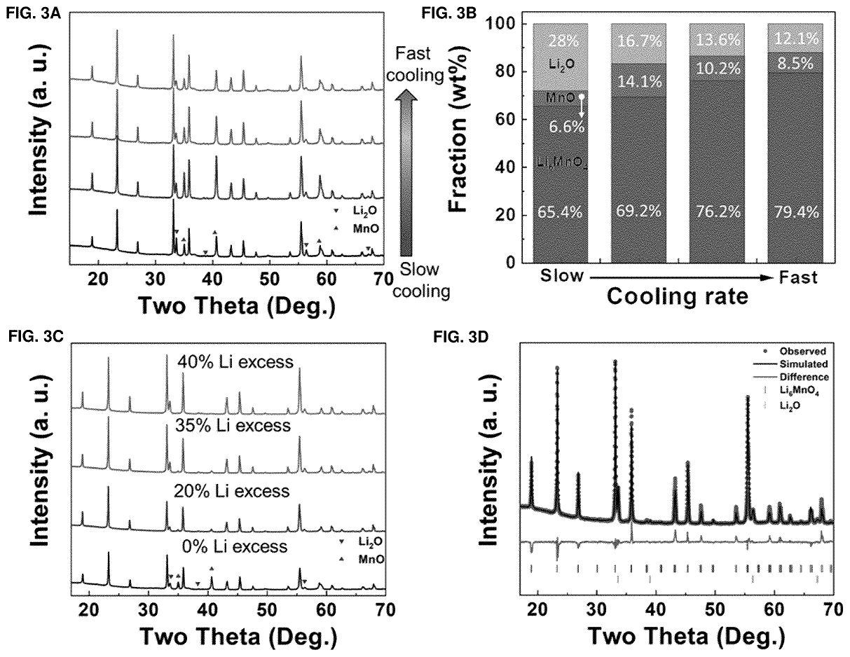

To examine the impact of the cooling rate on the purity of Li₆MnO₄, XRD patterns obtained from reaction products of Li₂O and MnO when held at 950° C. for 12 h under a continuous flow of the mixed gas (98% Ar, 2% H₂) but with varied cooling rates are shown in FIG. 3A. The ratios of Li₂O and MnO were kept fixed at 3:1 for all these experiments. For the slowest cooling, the furnace was turned off after the completion of the 12 hour dwell time. To slightly increase the cooling rate, the furnace was turned off and the insulating cover was opened immediately after the dwell. To accelerate the cooling rate further, the furnace's tube was removed from the heating element and cooled down while retaining a gas flow through it. The gas flow was maintained during the cooling to avoid any potential oxidation of Mn and unwanted side reactions upon air exposure. The fastest cooling was achieved by applying a cooling fan to the furnace's tube that was removed from the heating element.

From the XRD analysis, the purity of Li₆MnO₄ is found to increase substantially with faster cooling rates. This result is clearly evidenced by the prominent decrease in the peak intensity of the Li₂O and MnO impurities. FIG. 3B shows the refined weight fraction of Li₆MnO₄ in the samples obtained using varied cooling rates. The weight fraction of Li₆MnO₄ increases from ≈65% to ≈80% by weight. However, even with the fastest cooling rate, some Li₂O and MnO impurities still persist.

To further improve the purity of Li₆MnO₄, the use of excess Li₂O precursor was tested. In these experiments, the fastest cooling rate, as described above, was used. This is anticipated to be beneficial to increase reactive interfaces between MnO and Li₂O, allowing all the MnO particles to react to form Li₆MnO₄. Any unreacted Li₂O could be evaporated during the high-temperature synthesis process. In addition, some Li₂O residues might be lost in the washing procedure used after synthesis (described later in this EXAMPLE) in an attempt to purify the sample.

FIG. 3C shows the XRD patterns of samples synthesized with varied amounts of Li excess. With increasing levels of Li excess in the precursor mixture, the resulting product shows a decrease in the amount of MnO that is present. The peaks associated with MnO are completely undetectable once the Li-excess level reaches 40% (i.e., when the ratio of Li₂O to MnO is 4.2). Nevertheless, substantial amounts of the unreacted Li₂O impurity remain after each synthesis attempt.

The Li₆MnO₄ synthesized with 40% Li excess was subjected to phase quantification using Rietveld refinement as shown in FIG. 3D. For the Rietveld refinement, crystal structure data of Li₆MnO₄ (space group: P4₂/nmc) was used. This refinement suggests a weight fraction of 85.4% for Li₆MnO₄ (with lattice parameters a=6.632 Å, b=6.625 Å, and c=4.670 Å), which coexists with 14.6 wt. % Li₂O. Because the method used in this study cannot control the cooling rate precisely, the reproducibility of the synthesis process was tested. In the optimized synthesis condition, the purity of Li₆MnO₄ was 84.5±1.0 wt. %.

One scanning electron microscopy (SEM) image acquired from presumed Li₆MnO₄ particles in the sample showed 2 μm to 3 μm primary particles agglomerated to form a ≈40 μm secondary particle. To quantify the composition of the sample, inductively coupled plasma mass spectrometry (ICP-MS) measurements were performed, revealing a Li:Mn ratio of 8.5:1, which is close to the Li:Mn ratio in the precursor mixture. This result indicates that almost no Li has evaporated during the synthesis process. Given the overall sample composition and the weight fraction of each identified phase, the final synthesis product can be denoted as Li₆MnO₄·αLi₂O (α<1.25).

In an attempt to remove the Li₂O impurity, the sample was washed with water after synthesis. Unfortunately, it appears that Li₆MnO₄ is unstable in contact with water as it was found to completely transform into LiMn₂O₄ after the washing procedure. Nevertheless, the purity of Li₆MnO₄ obtained in this study is still reasonably high, which allows for the investigation of its intrinsic electrochemical properties and delithiation mechanisms as a potential artificial cathode additive for the first time in the following section.

### Example—Li Extraction Mechanisms

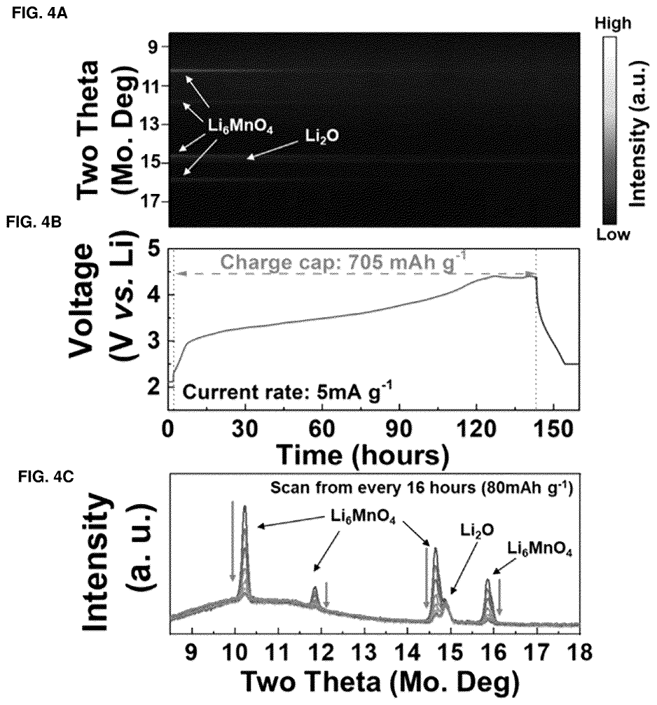

The Li extraction mechanisms of Li₆MnO₄ was investigated using in situ electrochemistry-XRD analysis. FIG. 4A shows the XRD patterns acquired during the charge and discharge of the synthesis product that shows the highest purity (85.4 wt. %) of Li₆MnO₄. FIG. 4B shows charge-discharge profiles measured from this sample, with a current density of 5 mA g⁻¹ in the voltage range of 4.5-2.5 V (vs Li/Li⁺). During the charging process, no prominent changes were observed in the peak positions of the XRD patterns. This result agrees with the previous report by one research group. They also found no change in the peak positions of Li₆MnO₄ after 0.25 Li ions were extracted, which led to the conclusion that Li cannot be extracted from the compound at reasonable voltages. However, it was found in this study that the peak intensity associated with Li₆MnO₄ does continuously decrease during the charging process. This is more clearly shown in FIG. 4C, which shows that the peak intensity of Li₆MnO₄ linearly decreases as a function of charging state. These results suggest that Li₆MnO₄ may become amorphous or poorly crystalline upon delithiation. Importantly, it was also found that Li₂O remains unchanged in XRD, both in terms of peak intensity and position, throughout the charging process, indicating all the observed charge capacity is derived from Li₆MnO₄. The total charge capacity of Li₆MnO₄ is found to be 705 mAh g⁻¹, corresponding to the extraction of ≈5 Li ions per formula unit.

A similar amorphization was observed in Li₆CoO₄ during the delithiation process by two research groups. Their studies did not observe a noticeable peak shift during the delithiation from the Li₆CoO₄ phase, but the XRD peaks from Li₆CoO₄ completely disappeared when more than 2 Li ions per formula unit were extracted. In the case of another sacrificial cathode additive, Li₅FeO₄, the structure was destroyed and transformed into a disordered rocksalt phase when 2 Li ions per formula unit were removed. In contrast, while the peak intensities of Li₆MnO₄ gradually decreased, they did not completely disappear nor convert into the disordered rocksalt phase until 5 Li ions per formula unit were removed.

Interestingly, the Li₆MnO₄ exhibits a non-negligible discharge capacity (≈60 mAh g⁻¹). It is suspected that the amorphous phase uptakes little Li ions during the discharging process. To understand whether the discharge capacity comes from the reduction of transition metal (i.e., Mn³⁺ to Mn²⁺), ex situ X-ray photoelectron spectroscopy (XPS) technique was employed. After charging up to 4.5 V, Mn 2p peak shifts to higher binding energy, indicating oxidation. However, the discharging to 2.5 V does not shift the Mn 2p peak to lower binding energy. This result confirms that the Mn is not reversibly reduced upon discharging. Therefore, it is highly likely that the discharge capacity is attributable to capacitive reactions.

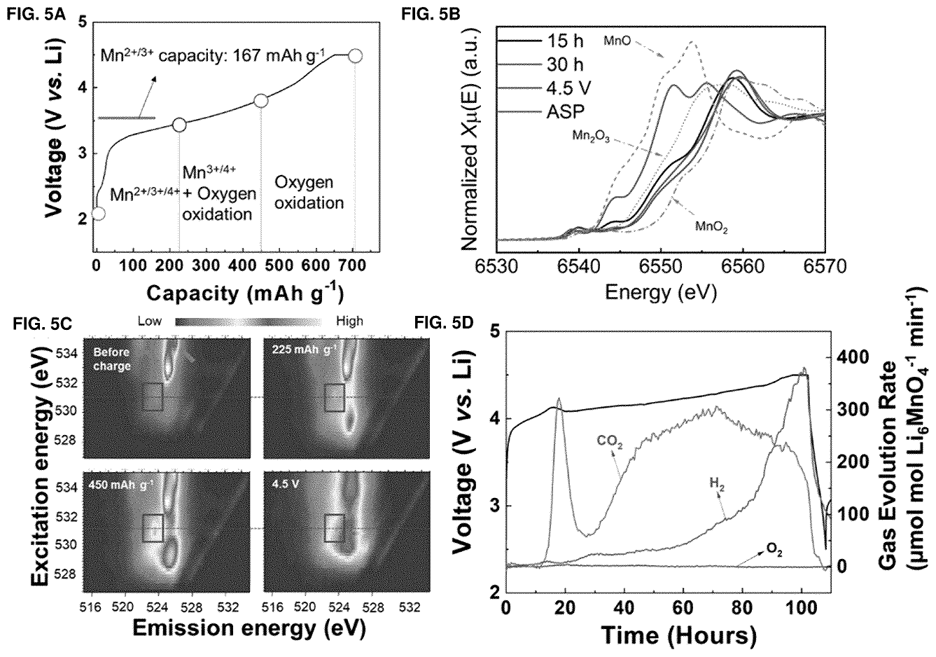

To better understand the Li extraction reaction mechanisms of Li₆MnO₄, ex situ bulk sensitive hard X-ray absorption near-edge structure (XANES) analysis was employed. In FIGS. 5A and 5B, the Mn K-edge spectra at different states of charge are compared with MnO (Mn²⁺), Mn₂O₃ (Mn³⁺), and MnO₂ (Mn⁴⁺) references. In the as-prepared pristine (ASP) sample, the Mn valence is close to +2, which is consistent with the Li₆MnO₄ chemical formula. Upon charging to 225 mAh g⁻¹, the Mn K-edge shifts to higher energy and slightly bypasses the Mn₂O₃ reference. This observation indicates that the oxidation state of Mn increases up to >+3. Charging to 450 mAh g⁻¹ further oxidizes the Mn, as evidenced by the Mn K-edge shift; however, the valence does not reach +4. When charged up to 4.5 V, the Mn K-edge slightly shifts to lower energy, which is related to the complicated redox coupling phenomenon between the O and Mn oxidation process at high voltage. This phenomenon indicates that Mn oxidation is not the only active redox mechanism and that oxygen oxidation may play a role.

FIG. 5C shows the O-K mapping of resonant inelastic X-ray scattering (mRIXS) to identify the contribution of oxygen oxidation in the Li-extraction process. The strong features at 525/534 and 522/534 of emission energy/excitation energy likely indicate the presence of Li₂CO₃. As no crystalline Li₂CO₃ was observed in the XRD analysis, it is expected that a poorly crystalline or amorphous Li₂CO₃ is present in the sample. When charging up to 450 mAh g⁻¹, these features weaken, indicating the decomposition of Li₂CO₃. More importantly, the feature highlighted by the box originates from oxidized oxygen species. The emergence of such a feature again indicates the oxygen oxidation to compensate for the Li extraction. As shown in FIG. 5C, the intensity of the oxidized oxygen feature starts to increase when the cathode is charged to 225 mAh g⁻¹, and the relative intensity of this feature is enhanced upon further oxidation up to 450 mAh g⁻¹. However, at the 4.5-V charged state, the oxidized oxygen feature were no longer observed, and pre-edge features near ≈528 eV of excitation energy showed a noticeable change, which suggests that the subsurface electronic structure is completely changed. This finding agrees with the completely diminished XRD peaks of Li₆MnO₄ after fully charging up to 4.5 V (FIG. 4C).

Differential electrochemical mass spectrometry (DEMS) was employed to investigate outgassing during the cycling of Li₆MnO₄ as shown in FIG. 5D. Large amounts of CO₂ and H₂ evolution were observed during the first charge, whereas no O₂ evolution was detected. The CO₂ evolution observed during the first charge occurs in two distinct peaks, including one relatively sharp peak occurring early during charging and a broader peak occurring over the latter portion of the first charge. The H₂ evolution occurs as a single peak that slowly grows over the course of the first charge and reaches a maximum at the end of the charge. CO₂ may arise due to the decomposition of native carbonate species (such as Li₂CO₃) on the surface of Li₆MnO₄ or the decomposition of the carbonate solvents in the electrolyte. In particular, given that the Li₂CO₃ feature disappeared during the initial charging process in the mRIXS analysis, the CO₂ evolution during the earlier charging process with the relatively sharp peak can likely be attributed to the decomposition of Li₂CO₃.

In contrast, H₂ evolution may result from an electrode crosstalk process in which electrolyte degradation at the Li₆MnO₄ surface generates protic electrolyte degradation products, which are subsequently reduced at the anode surface to form H₂. Although the mechanism underlying the electrolyte degradation that is responsible for much of the observed outgassing is unclear, it is likely that the interfacial reactivity of the Li₆MnO₄ is at least elevated due to the large amounts of anion redox occurring within the material. For example, the electrolyte degradation may be initiated by a reaction of the electrolyte solvent with reactive oxidized oxygen species formed during the charging of Li₆MnO₄. Although direct O₂ evolution is not observed, other oxidized oxygen species may be formed that subsequently react with the electrolyte and produce CO₂. The gas evolution from the lattice creates cracks in the Li₆MnO₄ particles as shown in SEM analysis.

### Example—Stability of Li₆MnO₄ in Ambient Air

The air stability of Li₆MnO₄ was evaluated. XRD patterns of Li₆MnO₄ electrodes before and after air exposure (24 h) show a peak located at ≈18° from PTFE binder used for the electrode preparation. After the air exposure for 24 h, the peak intensity of Li₆MnO₄ significantly decreases and new diffraction peaks appear. The new peaks evolved after the air exposure are well matched with Li₂CO₃ phase. It is expected that Li ions are removed from Li₆MnO₄ and it forms Li₂CO₃ by reacting with CO₂ in the air. Charge-discharge profiles of Li₆MnO₄ after air exposure (24 h) showed that Li₆MnO₄ could not be charged and exhibited a low charge capacity of ≈20 mAh g⁻¹. These results indicate instability of Li₆MnO₄ in ambient air.

### Example—Effect of Li₆MnO₄ Additive in Full Cells

To evaluate the effect of Li₆MnO₄ as a sacrificial cathode additive, full cells with and without Li₆MnO₄ were fabricated and tested. In this system, LiNi_{0.8}Mn_{0.1}Co_{0.1}O₂ (NMC811) as a cathode active material and SiOₓ-graphite composite as an anode active material were used. For the sample with Li₆MnO₄ additive, NMC811 and Li₆MnO₄ were mixed in a 9:1 ratio in mass (10 wt. % of Li₆MnO₄ additive).

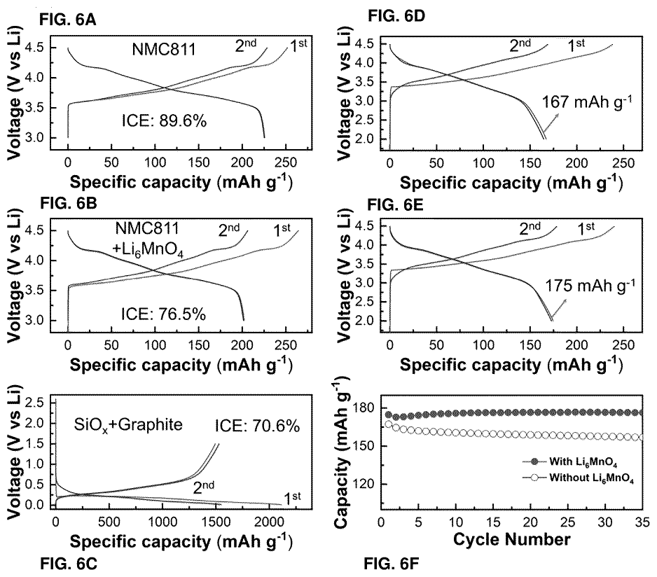

The NMC811 cathode and NMC811 with Li₆MnO₄ additive in a Li metal half-cell were tested first. FIGS. 6A and 6B show charge-discharge profiles of NMC811 without Li₆MnO₄ additive and NMC811 with Li₆MnO₄ additive, respectively, at 30 mA g⁻¹. NMC811 cathode delivers 251.9 and 225.8 mAh g⁻¹ for the first charge and discharge, respectively. The initial coulombic efficiency (ICE) is ≈89.6% for NMC811. When 10 wt. % of Li₆MnO₄ additive is used, the cathode shows 264.4 mAg⁻¹ for the first charge and 202.2 mAh g⁻¹ for the first discharge, exhibiting 76.5% of ICE. When the discharge capacity is re-calculated based on the NMC811 mass only, it becomes 224.7 mAh g⁻¹, which is close to the value obtained by NMC811 only. This result demonstrates that Li₆MnO₄ contributes to the charge capacity only as a sacrificial cathode additive.

The SiOₓ-graphite composite was used as an anode and tested the composite anode in a Li metal half-cell. FIG. 6C shows the initial two charge-discharge cycles of the SiOₓ-graphite composite anode at 250 mA g⁻¹. The SiOₓ-graphite composite anode exhibits 2114.7 mAh g⁻¹ of the first discharge capacity and 1493.7 mAh g⁻¹ of the first charge capacity with ICE of 70.6%.

Finally, full cells were assembled by combining NMC811 cathode without Li₆MnO₄ additive or NMC811 with Li₆MnO₄ additive and the SiOₓ-graphite composite anode. In the experiment, N/P ratio was fixed to be 1.0 based on the first charge capacity of the cathode and the first discharge capacity of the anode. FIGS. 6D and 6E show the charge-discharge profiles of the full cells with NMC811 without LiMnO₄ additive and NMC811 with Li₆MnO₄ additive, respectively, at 30 mA g⁻¹_{cathode}. The full cell with Li₆MnO₄ additive delivered 175 mAh g⁻¹ which was slightly higher than the cell without additive (167 mAh g⁻¹). When the discharge capacity was re-calculated based on the NMC811 mass only for the cell with Li₆MnO₄ additive, it became 194.4 mAh g⁻¹, indicating higher utilization of NMC811.

FIG. 6F shows the cycling stability of the full cells with and without Li₆MnO₄ additive. Notably, the cell with Li₆MnO₄ additive exhibited improved cycling performance compared to the control group. This result highlights the effectiveness of the synthesized Li₆MnO₄ as a sacrificial cathode additive.

### Example—Synthesis of Li_{1.2}Mn_{0.4}Ti_{0.4}O_{1.6}F_{0.4} and Li_{1.2}Mn_{0.4}Ti_{0.4}O₂

Li_{1.2}Mn_{0.4}Ti_{0.4}O_{1.6}F_{0.4} (LMTOF1244) and Li_{1.2}Mn_{0.4}Ti_{0.4}O₂ (LMTO1240) were synthesized by a solid-state synthesis method. For LMTOF1244, stoichiometric amounts of Li₆MnO₄, MnF₂, and TiO₂ were homogeneously mixed by ball milling at 150 RPM for 3 h using a planetary ball mill. For the synthesis of LMTO1240, Li₂O, Mn₂O₃, and TiO₂ were homogeneously mixed by ball milling at 150 RPM for 3 h using a planetary ball mill. For the synthesis of conventionally fluorinated LMTOF1244, stoichiometric amounts of Li₂O, MnO, TiO₂, and LiF were homogeneously mixed by ball milling at 150 RPM for 3 h using a planetary ball mill. The mixtures were pelletized with a mold with 6-mm diameter. The pelletized samples were then annealed to form the target phase at 800, 900, and 1000° C. for 4 h under continuous Ar gas flow.

### Example—Solid-State Synthesis of a Highly Fluorinated DRX

An alternative solid-state synthetic route to prepare the highly fluorinated Li_{1.2}Mn_{0.4}Ti_{0.4}O_{1.6}F_{0.4} (LMTOF1244) DRX compound was developed. The synthesis method uses high-purity Li₆MnO₄ as the sole source of Li and MnF₂ as the sole source of fluorine as well as TiO₂, in contrast to the conventional precursors of LiF, Li₂O, MnO, and TiO₂. It was hypothesized that Li₆MnO₄ and MnF₂ precursors, locking Li and F with Mn, would increase reactivity to form a DRX phase and enable incorporating fluorine in Mn-based DRX bulk. Lowering the synthesis temperature of the DRX phase can mitigate LiF evaporation, which is the major barrier to fluorine incorporation into the DRX bulk.

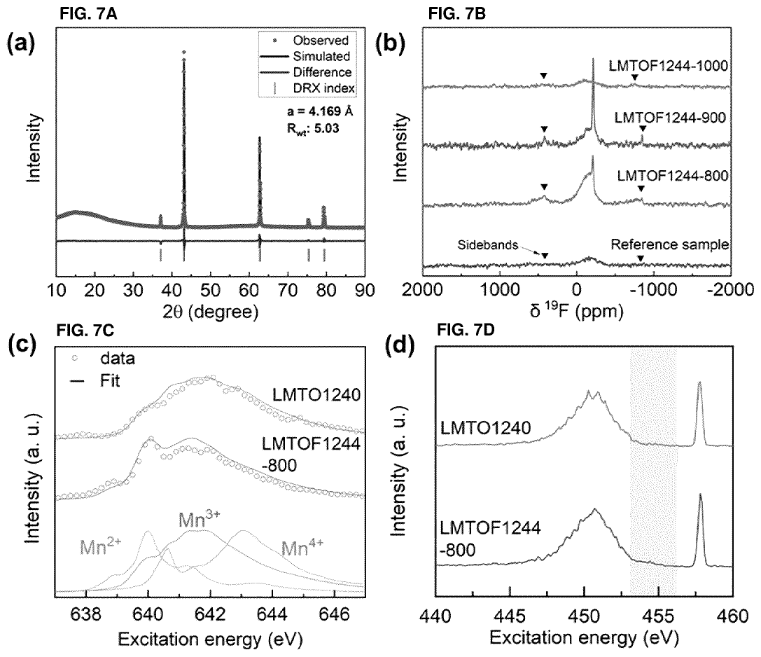

FIG. 7A shows an X-ray diffraction (XRD) pattern of the synthesized LMTOF1244 at 800° C. (hereafter, LMTOF1244-800); its refinement result yielded a lattice parameter of 4.169 Å with R_{wp}=5.03%. This lattice parameter falls within the typical range observed for Mn-rich DRX compounds. The XRD analysis indicated the presence of a single DRX phase, without noticeable crystalline impurity phases such as the commonly observed LiF. This phase purity is achieved despite the use of a relatively low synthesis temperature (800° C.) compared to that used in most DRX studies (≥900° C.). Previous studies have demonstrated that the fluorination level in the DRX bulk is typically lower than 10 mol % (F/(O+F)<0.1).

To quantify the overall composition of LMTOF1244-800, an inductively coupled plasma-mass spectroscopy (ICP-MS) analysis was performed, confirming a Li:Mn:Ti ratio of 1.278:0.380:0.342. The slightly higher Li content observed in the sample compared to the target composition of Li:Mn:Ti=1.2:0.4:0.4 is attributable to the presence of Li₂O impurity in Li₆MnO₄. The Li:Mn ratio in Li₆MnO₄ was confirmed by ICP-MS analysis to be 8.4:1, indicating Li excess in the Li₆MnO₄ precursor.

To determine whether amorphous impurity phases (e.g., Li₂O, LiF, Li₂CO₃) were present in the LMTOF1244-800 sample synthesized from Li₆MnO₄, MnF₂, and TiO₂, ⁷Li solid-state NMR (ssNMR) and ¹⁹F-ssNMR spectroscopy analysis were conducted (FIG. 7B). To understand how the synthesis conditions, including synthesis temperatures and precursor selection, affect the fluorine-incorporation level into the DRX bulk, ⁷Li ssNMR and ¹⁹F-ssNMR spectroscopy analysis were also conducted for LMTOF1244 synthesized at 900° C. (LMTOF1244-900) and 1000° C. (LMTOF1244-1000) and the LMTOF1244 sample synthesized using conventional precursors of LiF, Li₂O, MnO, and TiO₂ at 1000° C. (referred to hereafter as the reference sample). Briefly, the ⁷Li ssNMR results indicate the presence of minor Li-containing impurities (corresponding to 10 mol % of the total Li content) and a similar distribution of Li local environments in the DRX phase in all the samples. Notably, the amounts of Li-containing impurities in the materials agree with other DRX materials synthesized by solid-state routes. The ¹⁹F ssNMR spectra shown in FIG. 7B includes a broad signal spanning the 0 to −500 ppm range, resulting from the distribution of fluorine local environments in the paramagnetic (Mn-containing) rock salt phases. These results suggest some amount of fluorine incorporation into the DRX bulk in all the samples. Further, a direct comparison of the broad DRX ¹⁹F signal intensity in these spectra indicates that LMTOF1244-800 contains the most fluorine in the bulk DRX structure, followed by LMTOF1244-900. The spectra collected on these two samples also included an additional sharp signal at ≈−204 ppm, attributed to fluorine in a LiF impurity phase. This LiF impurity presumably fully volatilizes at temperatures >900° C. as it is not observed in the corresponding spectra.

Complementary fluorine-ion selective electrode (F-ISE) measurements were conducted on selected samples to obtain quantitative insights into the total F content. The results indicate a fluorine content of ≈0.36 in the LMTOF1244-800, which is significantly higher than the 0.12 F⁻ obtained for the reference LMTOF1244 sample. Combining these ¹⁹F ssNMR and F-ISE results, an upper and lower bound for the amount of fluorine incorporated into the DRX bulk can be derived. This analysis was performed on the LMTOF1244-800 sample. A fitting of the corresponding ¹⁹F ssNMR spectrum indicates that a paramagnetic signal from fluorine species in the DRX phase accounts for 80%±5% of the total ¹⁹F signal intensity, indicating a lower bound of ≈0.29 F⁻ for the fluorine content in the DRX phase as those fluorine species directly bounded to Mn in the DRX phase cannot be observed experimentally. An upper bound of ≈0.34 F⁻ (or 94% of the ≈0.36 F⁻ in the sample) in the DRX phase was obtained by scaling the fraction of the paramagnetic ¹⁹F ssNMR signal intensity obtained experimentally by the fraction of NMR-visible fluorine environments in the DRX phase (no Mn nearest neighbors) assuming a fully random distribution of cations and anions. Hence, at least ≈0.29 F⁻ and at most ≈0.34 F⁻ is incorporated into the DRX phase for the LMTOF1244-800 sample. Even the lower bound of ≈0.29 F⁻ is substantially higher than the fluorination content typically achieved by solid-state synthesis using conventional precursors. By combining the ICP-MS, F-ISE, ¹⁹F ss-NMR, and ⁷Li ss-NMR results, it was concluded that the composition of LMTOF1244-800 is Li_{1.23}Mn_{0.40}Ti_{0.37}O_{2-y}F_{y} (y=0.29-0.34).

To determine the average valence state of the Mn and Ti species in LMTOF1244-800, mapping of the inelastic X-ray scattering-inverse partial fluorescence yield (mRIXS-iPFY) for Mn-L₃ and RIXS for Ti-L₃ was used, as shown in FIGS. 7C and 7D. A characteristic Mn²⁺ signal was observed in the Mn spectrum collected on LMTOF1244-800, and the estimated valence state of Mn is +2.74. For comparison, fluorine-free DRX was synthesized and characterized, namely Li_{1.2}Mn_{0.4}Ti_{0.4}O₂ (hereafter LMTO1240), using Li₂O, Mn₂O₃, and TiO₂ at 1000° C. This sample did not show any Mn²⁺ signature signal, and the estimated valence state of Mn in LMTO1240 is +3.2 (FIG. 7C). A hard XAS analysis for the Mn K-edge also confirmed a lower oxidation state of Mn in LMTOF1244-800 than for the fluorine-free LMTO1240 sample. Ti-L₃ RIXS was used to determine whether a fraction of the Ti appears as Ti^{2+/3+} rather than in the expected Ti⁴⁺ oxidation state. As shown in FIG. 7D, the region where dd-excitation features are typically observed for Ti²⁺ and Ti³⁺ shows no signal intensity, indicating that all the Ti in both LMTOF1244-800 and LMTO1240 is in the +4 oxidation state.

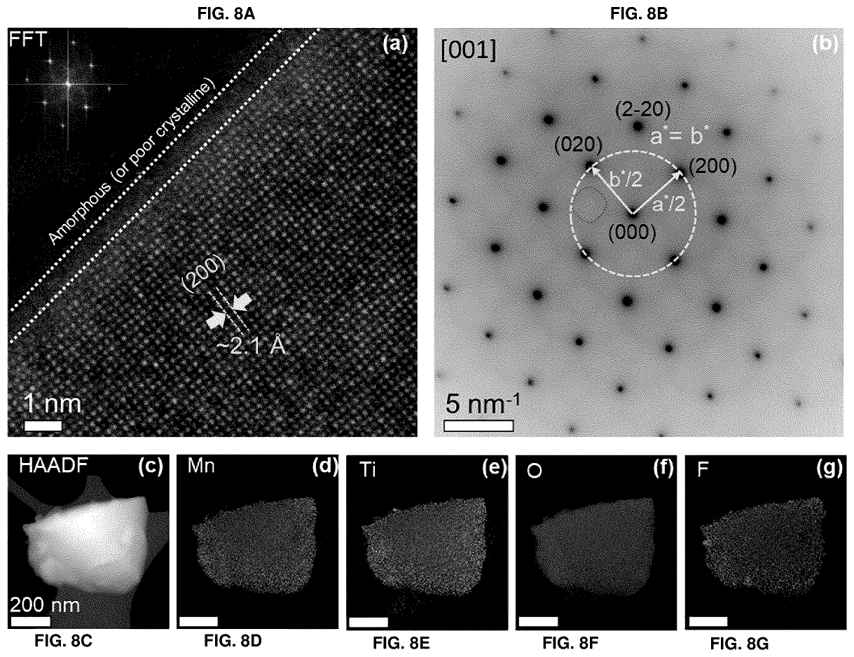

To better understand the distribution of fluorine in LMTOF1244-800, scanning transmission electron microscopy (STEM) and scanning electron microscopy (SEM) analysis with energy-dispersive X-ray spectroscopy (EDS) were performed. FIG. 8A shows an atomic-resolution high-angle annular dark-field imaging (HAADF) STEM image of LMTOF1244-800, and fast Fourier transform (FFT) of the image. The bright spots indicate transition-metal-rich columns, whereas the dark spots indicate Li-rich columns. The LMTOF1244-800 showed a well-crystallized disordered rock-salt structure in the inner side of the particle; however, a very thin (≈1 nm) layer of amorphous (or poorly crystalline) phase was confirmed at the particle surface. The formation of an amorphous or poorly crystalline thin layer is consistent with the observation of a small amount of LiF (and potentially additional Li₂CO₃ and Li₂O) impurities in the LMTOF1244-800 sample by ⁷Li and ¹⁹F ssNMR.

FIG. 8B shows a selected area electron diffraction (SAED) pattern of the LMTOF1244-800, which demonstrates the single crystalline with rock-salt structure (space group: Fm-3 m). The analysis of electron diffraction patterns revealed a lattice parameter of ≈4.2 Å, consistent with values obtained from XRD. For a cubic lattice, this corresponds to an atomic spacing of ≈2.1 Å, further confirmed through atomically resolved HAADF imaging. Aside from the reflection spots of the DRX structure, diffuse scattering patterns are observed surrounding the Bragg reflections, which suggests the existence of short-range order (SRO). A recent study found that the SRO in the DRX can be categorized into three types (tetrahedron-, octahedron-, and cube-type) and that these SROs directly affect Li percolation pathways and corresponding Li-transport behavior. The circle-like diffuse scattering pattern indicates octahedron-type SRO, which has better Li percolating behaviors than tetrahedron-type SRO. Interestingly, it was found that similar octahedron-type SRO for the LMTOF1244-800 and LMTOF1244-1000 samples (FIG. 8B), indicating that the synthesis temperature may not a critical factor in determining SROs in our system, possibly because SRO evolves during cooling.

FIGS. 8C-8G show HAADF images and EDS mapping results for LMTOF1244-800, which demonstrate a uniform distribution of Mn, Ti, and O as well as the presence of F in the bulk DRX. SEM/EDS analysis also confirmed the uniform distribution of each element within 5-6 μm-sized LMTOF1244-800 particles. Importantly, both TEM/EDS and SEM/EDS analyses confirm even distribution of F in the LMTOF1244-800 particle. This indicates that Fis not segregated at the surface.

### CONCLUSION

Further details regarding the embodiments described herein can be found in Haegyeom Kim et al., “Screening and Development of Sacrificial Cathode Additives for Lithium-Ion Batteries,” Advanced Energy Materials, 2025, 15, 2403946 and in Venkata Sai Avvaru et al., “Alternative Solid-State Synthesis Route for Highly Fluorinated Disordered Rock-Salt Cathode Materials for High-Energy Lithium-Ion Batteries,” Advanced Energy Materials, 2025, 15, 2500492, both of which are hereby incorporated by reference.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

What is claimed is:

1. A method comprising:
mixing Li₂O and MnO to form a mixture;
annealing the mixture at about 900° C. to 1100° C. for about 2 hours to 24 hours; and
cooling the mixture at a rate of about 30° C./min to 7000° C./min to form Li₆MnO₄.

2. The method of claim 1, wherein the mixing is performed for about 2 hours to 8 hours.

3. The method of claim 1, wherein the mixing is performed using a planetary mixer.

4. The method of claim 1, wherein the annealing is performed under flowing hydrogen and argon.

5. The method of claim 1, further comprising:
forming a compact of the mixture prior to the annealing the mixture.

6. The method of claim 1, further comprising:
mixing the Li₆MnO₄, MnF₂, and TiO₂ to form a second mixture;
ball milling the second mixture; and
after the ball milling, annealing the second mixture at about 800° C. to 850° C. for about 2 hours to 10 hours to form a compound, the compound being Li₁₊ₓMn_{y}Ti_{1-x-y}O_{2-z}F_{z}, with x about 0.1 to 0.4, with y about 0.3 to 0.7, and with z>0.2.

7. The method of claim 6, wherein the second mixture includes only the Li₆MnO₄, the MnF₂, and the TiO₂.

8. The method of claim 6, wherein ball milling is performed using a planetary ball mill.

9. The method of claim 6, wherein the ball milling is performed for about 1 hour to 10 hours.

10. The method of claim 6, wherein the annealing the second mixture is performed under an inert atmosphere.

11. The method of claim 6, wherein the annealing the second mixture is performed under flowing argon.

12. The method of claim 6, further comprising:
forming a compact of the second mixture prior to the annealing.

13. The method of claim 6, wherein the compound is Li_{1.23}Mn_{0.4}Ti_{0.37}O_{2-z}F_{z}, and wherein z is about 0.29 to 0.34.

14. The method of claim 6, wherein the compound is Li_{1.2}Mn_{0.4}Ti_{0.4}O_{1.6}F_{0.4}.

15. A method comprising:
mixing Li₆MnO₄, MnF₂, and TiO₂ to form a mixture;
ball milling the mixture; and
after the ball milling, annealing the mixture at about 800° C. to 850° C. for about 2 hours to 10 hours to form a compound, the compound being Li₁₊ₓMn_{y}Ti_{1-x-y}O_{2-z}F_{z}, with x about 0.1 to 0.4, with y about 0.3 to 0.7, and with z>0.2.

16. The method of claim 1, wherein the mixture includes only the Li₆MnO₄, the MnF₂, and the TiO₂.

17. The method of claim 1, wherein the ball milling is performed for about 1 hour to 10 hours.

18. The method of claim 1, wherein the compound is Li_{1.23}Mn_{0.4}Ti_{0.37}O_{2-z}F_{z}, and wherein z is about 0.29 to 0.34.

19. The method of claim 1, wherein the Li₆MnO₄ is synthesized by a method comprising:
mixing Li₂O and MnO to form a second mixture;
annealing the second mixture at about 900° C. to 1100° C. for about 2 hours to 24 hours; and
cooling the second mixture to synthesize the Li₆MnO₄, the cooling being at a rate of about 30° C./min to 7000° C./min.

20. A method comprising:
mixing Li₂O and MnO to form a mixture;
annealing the mixture at about 900° C. to 1100° C. for about 2 hours to 24 hours;
cooling the mixture at a rate of about 30° C./min to 7000° C./min to form Li₆MnO₄;
mixing MnF₂, TiO₂, and the Li₆MnO₄ to form a second mixture;
ball milling the second mixture; and
after the ball milling, annealing the second mixture at about 800° C. to 850° C. for about 2 hours to 10 hours to form a compound, the compound being Li₁₊ₓMn_{y}Ti_{1-x-y}O_{2-z}F_{z}, with x about 0.1 to 0.4, with y about 0.3 to 0.7, and with z>0.2.
